(19) United States
(12) Patent Application Publication
(10) Pub. No.: US 2008/0020878 A1
(43) Pub. Date: Jan. 24, 2008

(54) Chain roller and bracket assembly and methods thereof

(76) Inventor: Elden R. Carl, La Mesa, CA (US)

Correspondence Address: DAVID R PRESTON & ASSOCIATES APC, 5850 OBERLIN DRIVE, SUITE 300, SAN DIEGO, CA, 92121, US

(21) Appl. No.: 11/811,985

(22) Filed: Jun. 13, 2007

Related U.S. Application Data
(60) Provisional application No. 60/831,812, filed on Jul. 19, 2006.

(51) Int. Cl. F16H 7/08

(52) U.S. Cl. 474/133

(57) ABSTRACT

Device and methods for arresting the upward movement of a continuous loop chain used to power a motorcycle. A roller wheel is suspended in space directly over the drive chain by means of a bracket and associated assembly. The positioning of the roller is designed to prevent the drive chain from impacting and damaging other components of the motorcycle when the rear suspension is compressed fully. The apparatus is designed to fit existing fastener locations on the motorcycle so that installation requires no modification other than the replacement of the original fasteners supplied by the manufacturer.

### RELATED APPLICATIONS

The present application claims benefit of priority to U.S. Provisional Application Ser. No. 60/831,812, filed Jul. 19, 2006, entitled Chain Roller and Bracket Assembly and Methods Thereof, which is incorporated by reference in its entirety herein.

### FIELD OF INVENTION

The present invention relates generally to the field of chain rollers for motorcycles, and particularly to chain rollers and bracket assemblies and methods thereof for arresting the upward movement of a continuous loop chain of a motorcycle designed and fitted for motorcycles that are built without a chain roller.

### BACKGROUND OF THE INVENTION

The rear suspension of a motorcycle may include of many different components, but generally, there is some type of frame that connects the rear tire to the frame or chassis, some type of power delivery system that drives the rear wheel via a chain, belt, or shaft, and normally some type of suspension system such as shock absorber or spring. The suspensions system is designed to allow the rear wheel of the motorcycle to traverse up and down at a controlled rate in an attempt to maintain contact between the rear tire and driving surface, even when that surface is uneven, without adversely affecting the rider's ability to control the motorcycle. The chain on a motorcycle is designed to fit with some degree of slack so that the chain will not be overstretched during the movement of the rear wheel and swing arm.

On some motorcycles designed for unprepared surfaces, chain rollers are provided to limit the travel of the chain and swing arm to reduce the chance of damage to the motorcycle when the suspension travels the entire length of its design. The rollers also limit the actual up and down motion of the chain relative to the swing arm as the chain slack increases and decreases during swing arm motion and acceleration. However, some of the available motorcycles are not designed or equipped with chain rollers, and the chain can impact other components of the motorcycle, particularly the plastic engine air intake or “air box”, when the suspension nears full travel. While there has been a trend to produce better and safer motorcycle chain systems to avoid damage to other motorcycle compartments, further improvements in the effectiveness and safety of motorcycle chain systems are desirable and the present invention addresses the existing problems and provides related benefits.

### SUMMARY OF THE INVENTION

The present invention relates generally to the field of chain rollers for motorcycles, and particularly to chain rollers and bracket assemblies and methods thereof for arresting the upward movement of a continuous loop chain of a motorcycle designed and fitted for motorcycles that are built without a chain roller. The present invention is particularly adaptable as an addition that can works in conjunction with an existing motorcycle that is not equipped with a chain roller by utilizing fasteners that are designed to take advantage of fastener locations already present on the production model motorcycle. The present invention can be combined as an addition to any motorcycle for street or off-road applications.

The present invention recognizes that motorcycle chain systems can be made more safe and efficient using a chain rollers and bracket assembly for arresting the upward movement of a continuous loop chain of a motorcycle in order to avoid unwanted and damaging contact of the chain with other compartments of the motorcycle.

As a non-limiting introduction to the breadth of the present invention, the present invention includes several general and useful aspects, including a device for arresting the upward motion of a continuous loop chain engaged by at least two sprockets of the drive chain of a motorcycle including a bracket capable of being mounted on the frame of a motorcycle, means for mounting the bracket such that the bracket is aligned parallel to the drive chain of the motorcycle, and a roller wheel attached to the bracket capable of arresting the upward motion of the continuous loop chain.

### BRIEF DESCRIPTION OF THE DRAWINGS

FIG. 1 is a side view of the motorcycle on which the chain roller of the present invention is mounted.

FIG. 2 is a close-up side view of the motorcycle showing the positioning of the present invention with respect to the frame members and fastener locations.

FIG. 3 is a perspective view of the present invention showing the bracket one embodiment of the preferred shape and positioning of the fasteners that hold the bracket to the motorcycle frame.

FIG. 4 is a perspective view of an exploded diagram of a preferred embodiment of the present invention showing the sequence of parts that place the roller in the correct position in space.

FIG. 5 is a top view of the bracket and assembly of a preferred embodiment of the present invention in relation to the frame members and drive chain.

FIG. 6 is a side view of a preferred embodiment of the present invention mounted on a motorcycle and in use.

### DESCRIPTION OF A PREFERRED EMBODIMENT

In a preferred embodiment of the present invention, the chain roller assembly includes a bracket, which allows proper vertical positioning of the roller to allow protection for the air box and other components of the motorcycle, a spacer to allow proper horizontal positioning of the roller directly over the drive chain, a preferably polyurethane wheel that acts as the contact point between the assembly and the drive chain, and associated fasteners, washers, and retaining nuts to hold the bracket and roller in place while minimizing binding on the roller.

The bracket is designed to take advantage of fastener locations on the production model KLR-650. The forward bracket bolt is designed to replace the subframe bolt, which connects the forward chassis and rear subframe downtube on the left side of the motorcycle. The rear bracket bolt is designed to replace the subframe component fastener on the subframe downtube that supports the airbox (not shown) and battery cover. The function of this bracket is two-fold: to place the roller at the proper location in space to keep the drive chain from impacting other components on the motorcycle, and to resist the moment arm acting on the roller assembly by the impact of the chain. The preferred embodiment uses an aluminum bracket to reduce weight. The current design for the bracket utilizes curving lines to minimize the chance of crack formation. The bracket has three holes; the forward and rear holes align with fastener locations on the motorcycle to support the bracket, and the center hole allows proper locating of the actual roller assembly over the drive chain.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

### EXAMPLES

Example I

### Chain Roller and Bracket Assembly and Methods Thereof

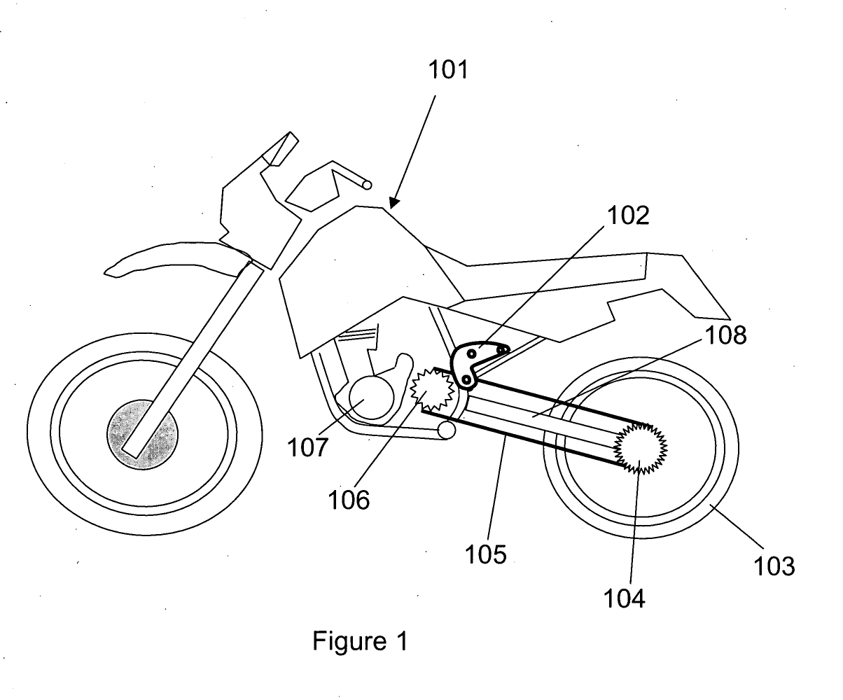

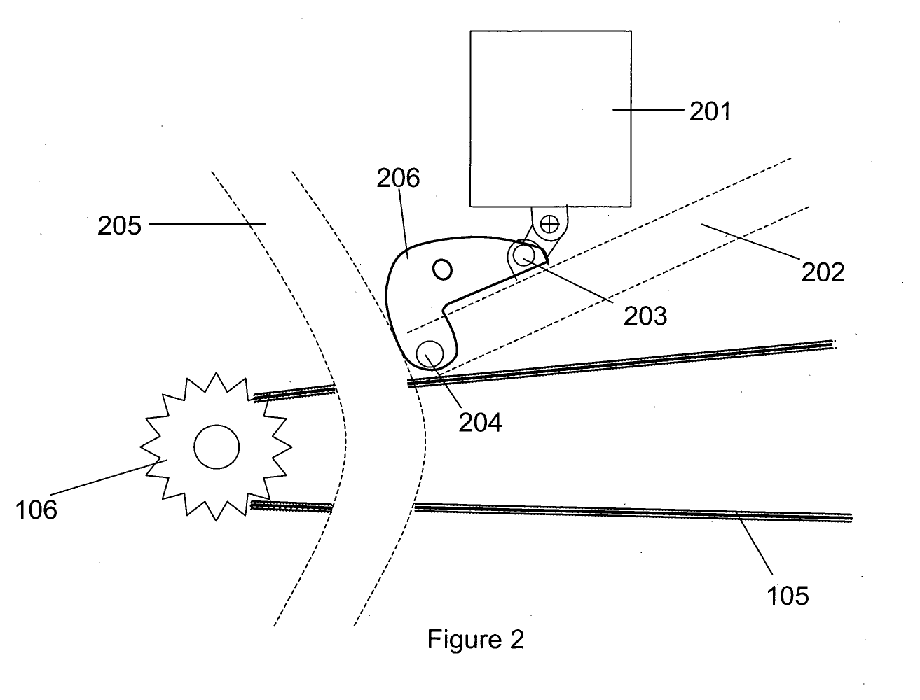

Referring to FIGS. 1 through 5, FIG. 1 shows a sketch of a KLR-650 motorcycle 101 having a continuous loop chain 105 trained about a pair of sprockets; the front sprocket 106 connected to the output shaft of the motorcycle engine 107, and the rear sprocket 104 connected to the rear wheel 103 of the motorcycle. The location of the device 102 is shown correctly positioned on the motorcycle.

Referring to FIGS. 1, 2 and 3, the device 102 is fastened to the motorcycle 101 at two locations. The forward location 204 is at the junction of the forward chassis 205 and the sub-frame down-tube 202. The second location 203 is on the sub-frame down-tube 202 used to provide a mounting location for the battery cover 201. The bracket 206 has holes drilled to align with locations 204 and 203. The circular hole 304 aligns with location 204, and the circular hole 301 aligns with location 203.

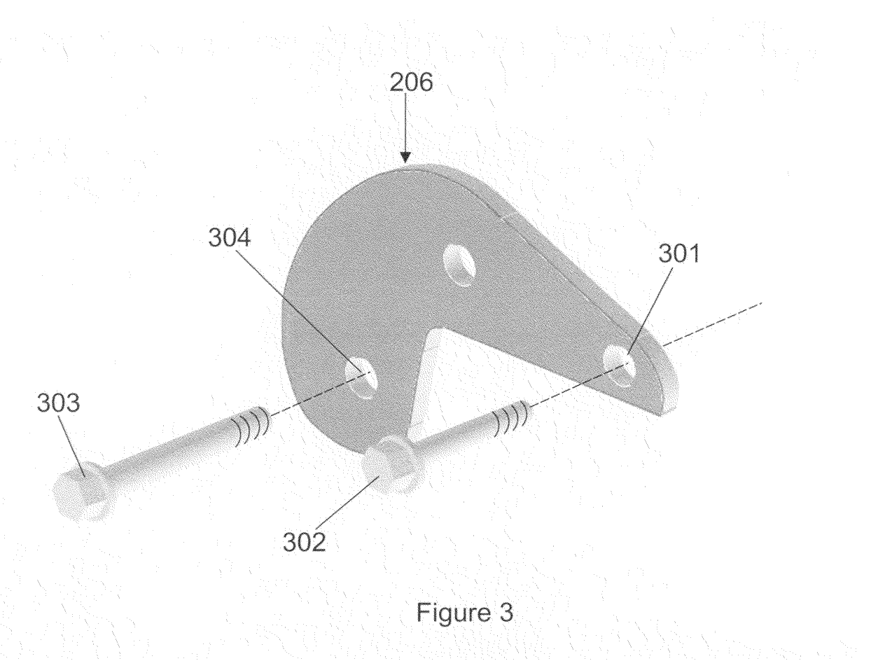

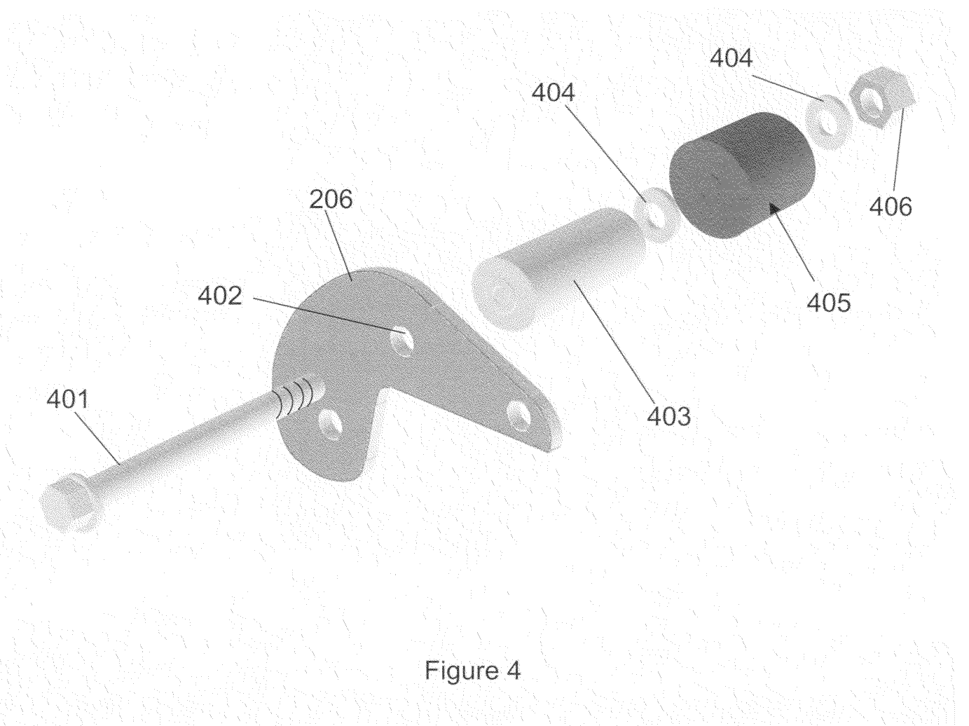

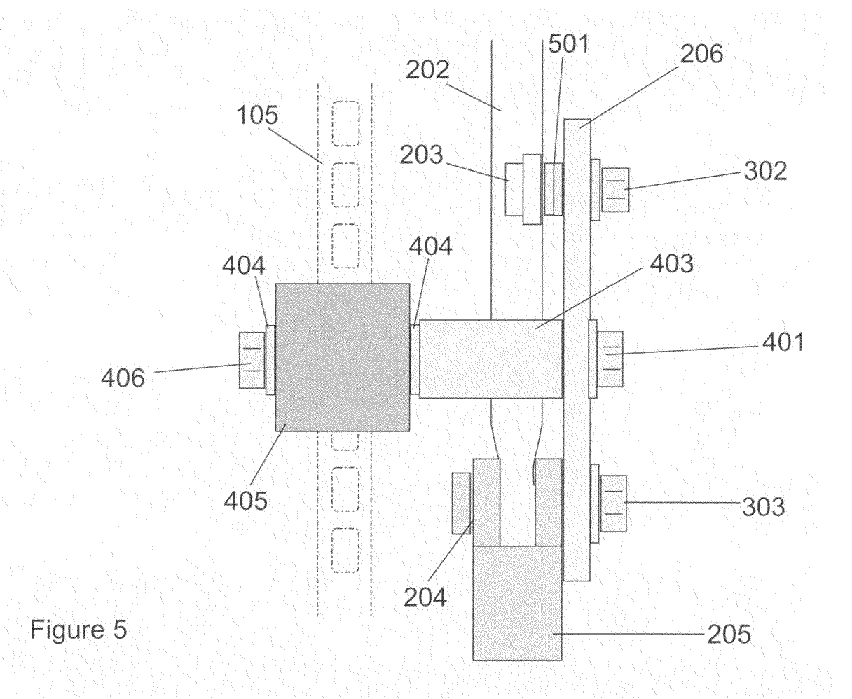

Now referring to FIGS. 3 and 4, the bracket 206 is held by bolt 303 which passes through hole 304 and threads into location 204, and by bolt 302 which passes through hole 301 and aligns with location 203. Bolt 401 will pass through hole 402 and provide proper positioning with respect to the drive chain 105. As indicated in FIG. 5, bolt 401 supports the following items in order starting from the inside of bracket 206: a spacer 403, preferably aluminum to reduce weight, followed by a washer 404 which is used to prevent binding, a roller wheel 405 in its preferred embodiment made from polyurethane or some similar material and optionally containing some type of bearing (not shown), followed by a washer 404 to prevent binding, and held in place by a lock-nut 406 which is tightened to hold the components in place. The spacer 403, washers 404, and roller wheel 405 can be of various dimensions, but should provide an overall length of approximately 40 millimeters measured from the inside of the bracket 206 to the center of the roller wheel 405 in order to be positioned directly above the chain 105. The roller wheel 405 is designed to turn, allowing the impacts of the chain 105 to be distributed around the surface of the roller wheel 405, thereby increasing the lifespan of the roller wheel 405.

As shown in FIG. 5, the bracket 206 is positioned parallel to the chain 105 by adding two washers 501 between the bracket 206 and the existing hole at location 203. This figure also shows how the proper sequencing of the spacer 403, the washers 404 and the roller wheel 405 contribute to the proper alignment directly above the chain 105.

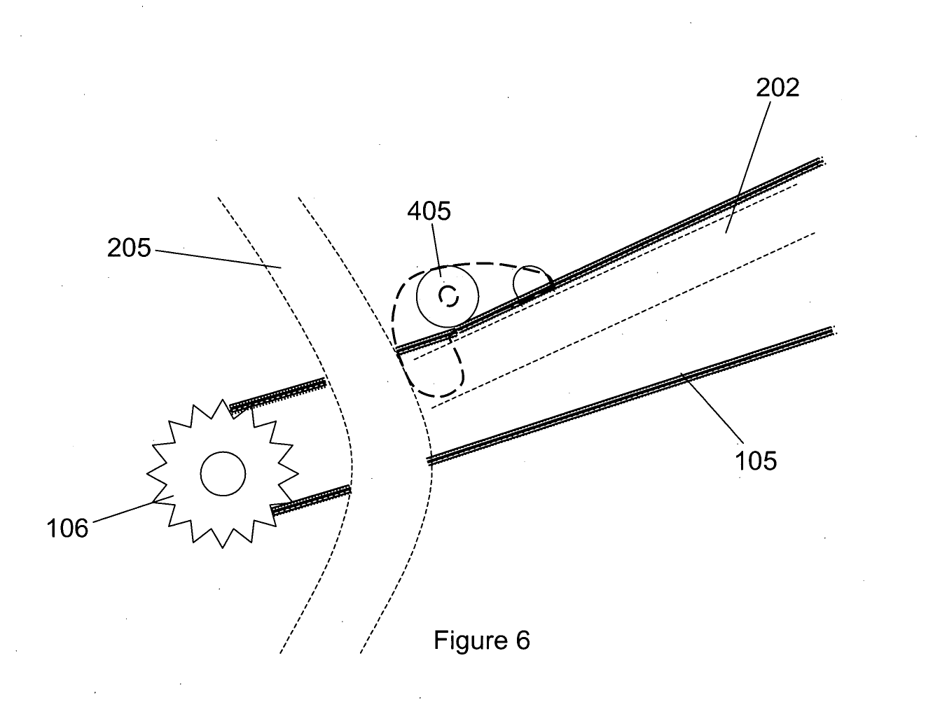

Referring to FIGS. 1 and 6, as the motorcycle's 101 suspension compresses, the rear wheel 103 and swing arm 108 will rise in relation to the device 102. Since the chain 105 connects the front sprocket 106, which is stationary, and the rear sprocket 104 connected to the rear wheel 103, the chain 105 will also rise in relation to the device 102. As FIG. 6 shows, the roller wheel 405 will come in contact with the top run of the chain 105, arresting its upward motion and preventing it from impacting the underside of the motorcycle 101.

Thus, there has been disclosed a chain roller and associated assembly which prevents the drive chain of a motorcycle, specifically a Kawasaki KLR-650 model motorcycle, from impacting the underside of the motorcycle during suspension compression. The roller wheel is positioned in space to provide proper arrestment of the chain in its upward motion and proper alignment with the drive chain. This positioning is accomplished by use of a bracket which fastens to existing locations on the motorcycle, and which also supports a spacer and roller wheel assembly.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims.

What is claimed is:

1. A device for arresting the upward motion of a continuous loop chain engaged by at least two sprockets of the drive chain of a motorcycle comprising:
a) a bracket capable of being mounted on the frame of a motorcycle;
b) means for mounting said bracket such that said bracket is aligned parallel to the drive chain of the motorcycle; and
c) a roller wheel attached to said bracket capable of arresting the upward motion of the continuous loop chain.

2. The device of claim 1, wherein said bracket comprises a vertical member and a horizontal member in a substantially L-shaped configuration.

3. The device of claim 1 wherein said means for mounting said bracket comprises one or more bolt fasteners that are designed to take advantage of fastener locations already present on the production model motorcycle.

4. The device of claim 1, wherein said roller wheel comprises bearing means such that when said continuous loop chain comes into contact with said roller wheel, said roller wheel turns with the movement of said continuous loop chain.
